(19) United States
(12) Patent Application Publication
(10) Pub. No.: US 2013/0159200 A1
(43) Pub. Date: Jun. 20, 2013

(54) METHOD, SYSTEM, AND APPARATUS FOR SERVICING EQUIPMENT IN THE FIELD

(71) Applicant: Accenture Global Services Limited, Dublin (IE)

(72) Inventors: Sanjoy PAUL, Bangalore (IN); Gurdeep Singh Virdi, Bangalore (IN); Sankalp SHARMA, Delhi (IN)

(73) Assignee: ACCENTURE GLOBAL SERVICES LIMITED, Dublin (IE)

(21) Appl. No.: 13/707,097

(22) Filed: Dec. 6, 2012

(30) Foreign Application Priority Data
Dec. 16, 2011 (IN) 4407/CHE/2011

(51) Int. Cl. G06Q 30/00

(52) U.S. Cl. CPC G06Q 30/012
USPC 705/305

(57) ABSTRACT

System, techniques, and apparatus are provided for servicing equipment. Context information associated with the equipment may be obtained by a processing device. The processing device may further obtain expert information associated with the equipment based on the context information. The processing device is operative to provide service information including information describing how the equipment was serviced. This service information may be used to generate updated expert information.

### FIELD FIELD

The instant disclosure relates generally to collaboration on the spot (COTS) techniques and, more specifically, to feedback-based techniques for servicing equipment.

### BACKGROUND

It is oftentimes difficult to bring certain types of equipment into a repair shop for repair or maintenance. For example, equipment may be too large to move without undue exertion or expense. Accordingly, it is frequently necessary for technicians and engineers to perform repair operations or maintenance “in the field.” That is to say, it is often necessary for technicians and engineers to travel to the location of the equipment (e.g., within a business or home) and service it on-site.

While on-site repairs may be effective where the technician/engineer charged with making the repair is particularly skilled, on-site repairs can be extremely challenging where the technician/engineer has a rudimentary understanding of the equipment at issue. Further compounding this issue is the fact that technicians/engineers servicing equipment in the field rarely have access to many sources of information that would be helpful in solving the particular equipment problem that they are faced with.

In addition, conventional field-repair techniques oftentimes fail to make-use of information describing how a particular equipment problem was successfully resolved and/or the identity of the technician/engineer who solved it. As such, any possible efficiency gains that could be realized by making use of this information is lost. For example, failure to adequately use this information can result in: (1) higher prices for the equipment itself (e.g., where the manufacturer of the equipment has to offset maintenance costs by increasing the cost of the equipment to consumers); (2) higher costs associated with the technicians/engineers (e.g., it may be necessary to employ highly skilled technicians/engineers, who command considerable compensation as compared to a semi-skilled/rudimentary technician/engineer, in order to address any problems with equipment in the field); and (3) poor customer service satisfaction (e.g., where a technician/expert has to make multiple trips to the equipment site in order to fix a problem that could have been fixed in a single trip with the assistance of certain information).

Accordingly, it is desirable to provide techniques for servicing equipment in the field that overcome many of the problems associated with conventional field-repair techniques.

### SUMMARY

The instant disclosure describes a system, techniques, and apparatus for servicing equipment (e.g., a television set) located in the field (e.g., at a consumer's home). To this end, in one example, a system for servicing equipment is provided. The system includes a first processing device and a second processing device in communication with the first processing device. The first and second processing devices may communicate, for example, over a suitable wireless network, as in the case where the first processing device is a mobile communication device such as a mobile phone, smart phone, tablet computer, etc. Continuing with this example, the first processing device is operative to obtain context information associated with the equipment scheduled for service.

As used herein, context information includes, but is not limited to, information describing the equipment scheduled for service generally (e.g., a model/serial number for a television set) and/or the components making up the equipment (e.g., a model/serial number for a picture tube in the television set). Thus, at a minimum, context information includes equipment identification information that describes the equipment scheduled for service generally and/or component identification information that describes at least one component of the equipment scheduled for service. Context information may be obtained by the first processing device in a variety of ways. For example, context information may be obtained by (1) scanning an optical code associated with the equipment (or component therein) using the first processing device or a peripheral device associated with the first processing device, (2) obtaining RFID tag information associated with the equipment (e.g., via an RFID tag reader included within or peripheral to the first processing device), (3) by taking a picture or capturing a video of the equipment using the first processing device or a peripheral device, (4) by obtaining an audio description of the equipment (e.g., via a technician/engineer verbally describing the equipment into a microphone), or (5) by obtaining a textual description of the equipment (e.g., via a technician/engineer typing a description of the equipment into the first processing device using, for example, a keypad). By retrieving context information in this manner, the choice of which particular context information to obtain is non-discretionary. That is to say, the same context information may be retrieved regardless of the specialty associated with the particular technician/engineer charged with servicing the equipment.

The first processing device is operative to transmit the obtained context information to the second processing device for further processing. The second processing device, which may comprise a suitable server computer or the like, is operative to generate expert information associated with the equipment based on the context information. Expert information may take on a variety of forms in accordance with the teachings of the instant disclosure. For example, expert information may include solution information. Solution information includes information describing solutions to frequently encountered problems with the equipment (e.g., “How To” documents, Frequently Occurring Issues with the equipment type or the specific equipment, video walkthroughs, etc.). Expert information may also include equipment expert identification information and component expert identification information. Equipment expert identification information includes information describing at least one expert that is knowledgeable about the equipment generally. Component expert identification information includes information describing at least one expert knowledgeable about at least one component of the equipment. Furthermore, expert information may include local expert identification information and local component identification information. Local expert identification information includes information describing at least one expert knowledgeable about the equipment generally and located within a predefined vicinity of the equipment. Similarly, local component expert identification information includes information describing at least one expert knowledgeable about at least one component of the equipment and located within a predefined vicinity of the equipment. Further still, expert information may include equipment documentation information. Equipment documentation information includes information describing one or more documents (e.g., white papers, user manuals, etc.) associated with the equipment. In one example, the equipment documentation information includes the documents associated with the equipment themselves (e.g., electronic copies of the white papers, user manuals, etc.).

The second processing device is further operative to transmit the generated expert information to the first processing device. Accordingly, the first processing device is operative to obtain the expert information associated with the equipment based on the context information. A technician/engineer working in the field at the location of the equipment may then use the first processing device to review the obtained expert information, and use the obtained expert information to service the equipment. After the equipment has been serviced, the technician/engineer may then use the first processing device to provide service information, for example, to the second processing device. Service information includes information that describes how the equipment was serviced (e.g., which component was defective and needed to be replaced, specific actions taken during the service, the outcome of the service, etc.). The second processing device may receive the service information and use it to generate updated expert information. In one example, the second processing device is operative to generate updated expert information based on the service information by modifying the solution information, equipment expert identification information, the component expert identification information, the local expert identification information, the local component expert identification information, and/or the equipment documentation information. In this manner, the expert information may continuously increase in relevance as service information is processed.

In one embodiment of the instant disclosure, an apparatus for servicing equipment is provided. In this example, the apparatus may include a processing device and memory operatively connected thereto. The memory may include executable instructions that when executed by the processing device, cause the processing device to (1) obtain context information associated with the equipment being serviced, (2) obtain expert information associated with the equipment being serviced, and (3) provide service information, such as the service information described above.

In one example, the memory also includes expert information, such as the expert information described above. Thus, in this example, it may not be necessary for the apparatus to obtain the expert information from another processing device. Rather, the expert information may be stored locally within the memory of the apparatus (e.g., in a local cache) such that the technician/engineer utilizing the apparatus may obtain valuable expert information even when, for example, there is no network connectivity allowing the apparatus to obtain the expert information from a remote source. That is to say, in this example, the processing device of the apparatus may obtain the expert information from its memory.

In another example, the apparatus also includes a transceiver operatively connected to the processing device. The transceiver is operative to transmit context information to a second processing device and obtain expert information from the second processing device. In still another example, the processing device of the apparatus is operative to check for network connectivity prior to obtaining the expert information from the second processing device.

Related methods and computer readable media for carrying out the functionality of the system and apparatus are also disclosed.

### BRIEF DESCRIPTION OF THE DRAWINGS

The features described in this disclosure are set forth with particularity in the appended claims. These features will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a block diagram illustrating one example of a communication device suitable for use within a system for servicing equipment in accordance with the instant disclosure;

FIG. 2 is a block diagram illustrating one example of a computing device suitable for use within a system for servicing equipment in accordance with the instant disclosure;

FIG. 3 is a block diagram illustrating one example of a system for servicing equipment in accordance with the instant disclosure;

FIG. 4 illustrates one example of a graphical user interface that may be generated for display on a communication device in accordance with the instant disclosure;

FIG. 5 is a flowchart generally depicting one example of a method for servicing equipment in accordance with the instant disclosure; and

FIG. 6 is a block diagram illustrating one example of a database structure for storing the information used by the system for servicing equipment in accordance with the instant disclosure;

FIG. 7 is a block diagram illustrating one example of a system including an apparatus for servicing equipment in accordance with the instant disclosure.

### DETAILED DESCRIPTION

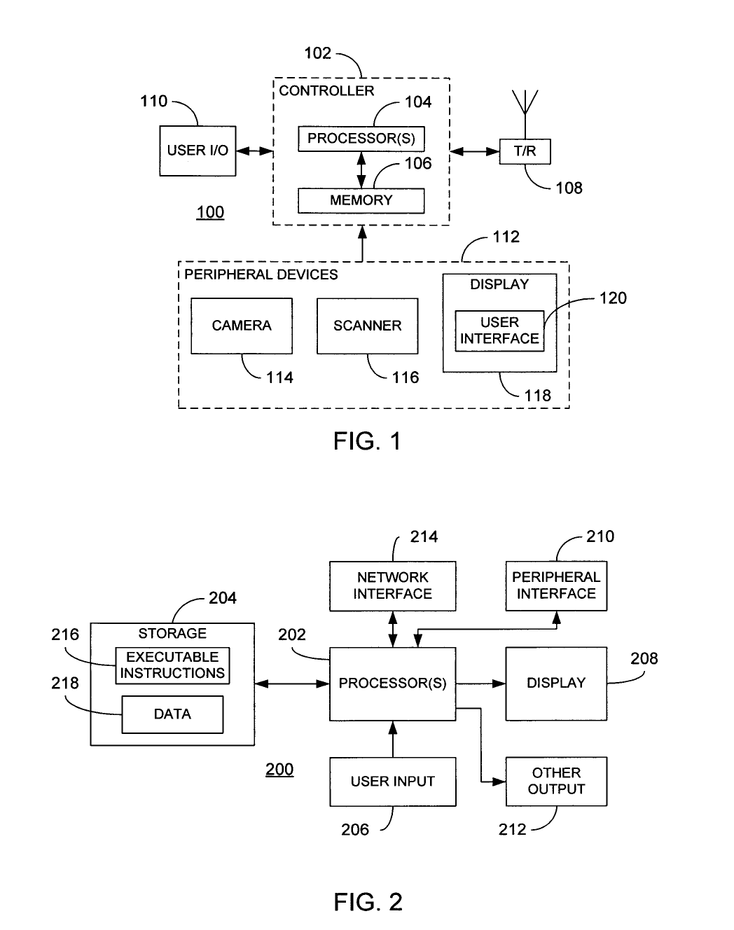

Referring now to FIG. 1, one example of a communication device 100 for use within a system 300 for servicing equipment is illustrated. The communication device 100 may be used to implement, for example, one or more components of the system 300, as described in greater detail below. The communication device may comprise, for example, a cellular phone, a smart phone, a personal digital assistant (PDA), a tablet (e.g., an Apple™ iPad™), a laptop computer, or any other suitable portable communication device capable of performing the processing described herein.

In the illustrated example, communication device 100 includes a controller 102, a transceiver 108, a user input/output interface 110, and peripheral devices 112. Controller 102 includes one or more processors 104 and memory 106. In an embodiment, the one or more processors 104 may include one or more devices such as microprocessors, microcontrollers, digital signal processors, or combinations thereof, capable of executing stored instructions and operating upon stored data that is stored in, for example, memory 106. Memory 106 may include one or more devices such as volatile or nonvolatile memory including, but not limited to, random access memory (RAM) or read only memory (ROM). Further still, memory 106 may be embodied in a variety of forms, such as a hard drive, optical disc drive, floppy disc drive, etc. Processor and memory arrangements of the types illustrated in FIG. 1 are well known to those having ordinary skill in the art. In one embodiment, the processing techniques described herein are implemented as a combination of executable instructions and data within the memory 106 used to control operation of, and operated upon by, the one or more processors 104.

The user input/output 110 may include any suitable components for receiving input from, and/or communicating output to, a user. For example, user input components could include a keypad, a touch screen, a mouse, a microphone and suitable voice recognition application, etc. User output components could include, for example, speaker(s), light(s) (e.g., one or more LED lights), buzzer(s) (e.g., one or more components capable of vibrating to alert the user, for example, of an incoming telephone call), etc. Other suitable input/output components will be discussed below with regard to peripheral devices 112. The transceiver 108 may comprise one or more suitable transceivers capable of transmitting and receiving information as known in the art. For example, the transceiver 108 may transmit and receive information using wireless communication resources implementing any of a variety of communication protocols, such as TDM (time-division multiplexed) slots, carrier frequencies, a pair of carrier frequencies, or any other radio frequency (RF) transmission media. Further still, although the transceiver 108 is illustrated in FIG. 1 as being wireless, those having ordinary skill in the art will appreciate that the transceiver may be additionally/alternatively capable of supporting communications using wired communication resources.

Peripheral devices 112 are any devices external to the communication device 100 that may nevertheless interact with the communication device 100, non-limiting examples of which include a camera 114, a scanner 116, and a display 120. The camera 114 may comprise any suitable camera capable of capturing still image and/or video data using techniques known in the art. In one example, the camera 114 may include a digital camera configured to capture an image and/or video. The captured image/video may be stored locally, for example, in memory 106. The scanner 116 may include any suitable scanner capable of performing scanning operations using techniques known in the art. For example, the scanner 116 may be configured to perform scanning operations in accordance with well-known scanning techniques. These scanning techniques may include, for example, pen-type scanning, laser scanning, charge-coupled device array (CCD) scanning, omni-directional barcode scanning, quick response (QR) code scanning, etc. Thus, the scanner 116 is configured to scan one or more optical codes (e.g., QR codes, bar codes, etc.) and the like using techniques well-known in the art. In one example, the camera 114 is configured to perform scanning operations as well. For example, in an embodiment, the camera 114 is operative to capture an image/video of a QR code (e.g., a QR code located on equipment sought to be serviced) for further processing. Capturing an image/video of an optical code using, for example, the camera 114 for further processing constitutes “scanning” within the meaning of the instant disclosure.

Display 118 may include any conventional integrated or external display mechanism such as a LED display, cathode ray tube (CRT) display, plasma display, LCD display, or any other display mechanism known to those having ordinary skill in the art. In an embodiment, the display 118, in conjunction with suitable stored instructions (e.g., suitable stored instructions stored in memory 106), may be used to implement a graphical user interface, such as graphical user interface 120. Implementation of a graphical user interface in this manner is well known to those having ordinary skill in the art. Additionally, as noted previously, peripheral devices such as the display 118 may instead be incorporated into the communication device 100 as part of, for example, the user input/output 110.

FIG. 2 illustrates a representative computing device 200 that may be used to implement one or more components of the system 300 described in the instant disclosure. The device 200 comprises a processor 202 coupled to a storage component 204. The storage component 204, in turn, comprises stored executable instructions 216 and data 218. In an embodiment, the processor 202 may comprise one or more of a microprocessor, microcontroller, digital signal processor, co-processor or the like or combinations thereof capable of executing the stored instructions 216 and operating upon the stored data 218. Likewise, the storage component 204 may comprise one or more devices such as volatile or nonvolatile memory including, but not limited to, random access memory (RAM) or read only memory (ROM). Further still, the storage component 204 may be embodied in a variety of forms, such as a hard drive, optical disc drive, floppy disc drive, etc. Processor and storage arrangements of the types illustrated in FIG. 2 are well known to those having ordinary skill in the art. In one embodiment, the processing techniques described herein are implemented as a combination of executable instructions and data within the storage component 204.

As shown, the device 200 may comprise one or more user input devices 206, a display 208, a peripheral interface 210, other output devices 212 and a network interface 214 in communication with the processor 202. The user input device 206 may comprise any mechanism for providing user input to the processor 202. For example, the user input device 206 may comprise a keyboard, a mouse, a touch screen, microphone and suitable voice recognition application, or any other means whereby a user of the device 200 may provide input data to the processor 202. The display 208, may comprise any conventional display mechanism such as a cathode ray tube (CRT), flat panel display, or any other display mechanism known to those having ordinary skill in the art. In an embodiment, the display 208, in conjunction with suitable stored instructions 216, may be used to implement a graphical user interface. Implementation of a graphical user interface in this manner is well known to those having ordinary skill in the art.

The peripheral interface 210 may include the hardware, firmware and/or software necessary for communication with various peripheral devices, such as media drives (e.g., magnetic disk or optical disk drives), other processing devices or any other input source used in connection with the instant techniques. Likewise, the other output device(s) 212 may optionally comprise similar media drive mechanisms, other processing devices or other output destinations capable of providing information to a user of the device 200, such as speakers, LEDs, tactile outputs, etc. Finally, the network interface 214 may comprise hardware, firmware and/or software that allows the processor 202 to communicate with other devices via wired or wireless networks, whether local or wide area, private or public, as known in the art. For example, such networks may include the World Wide Web or Internet, or private enterprise networks, as known in the art.

While the devices 100 and 200 have been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the devices 100 and 200 may include a greater or lesser number of components than those illustrated. Once again, those of ordinary skill in the art will appreciate the wide number of variations that may be used is this manner. Further still, although a single computing device 200 is illustrated in FIG. 2, it is understood that a combination of such computing devices may be configured to operate in conjunction (for example, using known networking techniques) to implement the teachings of the instant disclosure.

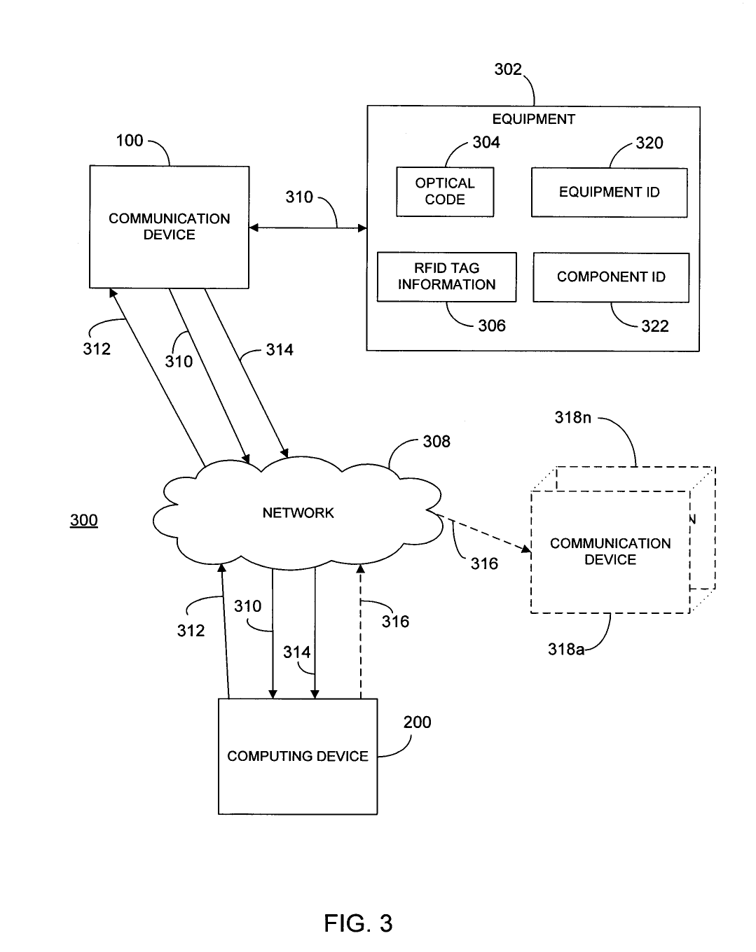

FIG. 3 illustrates one example of a system 300 for implementing the teachings of the instant disclosure. System 300 includes a communication device 100 in communication with a computing device 200 over a network 308. Communication device 100 and computing device 200 may include the components and perform the functionality discussed above with regard to FIG. 1 and FIG. 2, respectively. Network 308 may include any wired or wireless networks, whether local or wide area, private or public. For example, networks 308 may include the World Wide Web or Internet, or a private enterprise network, as known in the art. In one example, system 300 operates as follows.

A technician/engineer tasked with servicing equipment 302 may use the communication device 100 to obtain context information 310 associated with the equipment. As used herein, equipment 302 may include any equipment in need of maintenance/repair/diagnostic testing/etc., such as, but not limited to, electronics equipment (e.g., a television set), heavy equipment (e.g., a bulldozer), home appliance equipment (e.g., a washing machine), or any other equipment in need of service. As used herein, context information 310 includes information describing the equipment scheduled for service generally (e.g., a model/serial number for a television set) and/or the components making up the equipment (e.g., a model/serial number for a picture tube in the television set). Thus, at a minimum, context information 310 includes equipment identification information 320 that describes the equipment 302 scheduled for service generally and/or component identification information 322 that describes at least one component of the equipment 302 scheduled for service. However, it is understood that context information 310 may include virtually any type of additional information regarding the equipment in question. By way of non-limiting example, the context information 310 may include information regarding the specific location of the equipment or service history of the equipment. The technician/engineer may obtain the context information 310 in a variety of ways.

In one example, the camera 114 or the scanner 116 of the communication device may be used to scan an optical code 304 associated with the equipment 302. For example, oftentimes an optical code 304 will be present on the equipment itself 302 or in the direct vicinity of the equipment 302. The optical code 304 may include any suitable optical code known in the art such as, for example, a quick response (QR) code or a bar code. Depending on the particular optical code 304 associated with the equipment 302, the camera 114 or the scanner 116 may be used to obtain this information. For example, while some optical codes (e.g., a QR code) can be obtained by simply capturing an image/video of the code using the camera 114, other optical codes may require the scanner 116 to obtain the code (e.g., by performing laser scanning on the code).

In another example, an RFID tag reader (not shown) of the communication device 100 may be used to obtain RFID tag information 306 associated with the equipment 302 using techniques known in the art. As with the optical code discussed above, the RFID tag information 306 will include context information 310 describing, for example, information about the equipment 302 generally and/or information about components of the equipment 302.

In one embodiment, the technician/engineer may visually inspect the equipment to ascertain context information 310. For example, the technician/engineer may identify equipment identification information 320 (e.g., a model and/or serial number for the equipment) associated with the equipment 302. Similarly, the technician/engineer may identify component identification information 322 (e.g., a model and/or serial number for a component of the equipment 302) associated with the equipment. Using the user input/output interface 110 of the communication device 100, the technician/engineer can manually enter the equipment identification information 320 and/or component identification information 322 into the communication device 100. For example, a technician/engineer could type context information 310, such as an equipment model/serial number, into the communication device 100 using a keypad or verbally enter context information 310 into the communication device 100 using a microphone of the communication device 100 (i.e., speak context information into the device 100). This information may be stored, for example, in the memory 106 of the communication device 106 for further processing. Further in this regard, the technician/engineer could obtain service history regarding the equipment from ledgers or service logs associated with the equipment or from owners of the equipment and manually enter such service history information. This may be particularly desirable in those instances in which a given service call is the first service call by this service provider, i.e., in which there is no stored service history already.

In still another example, the technician/engineer may use the camera 114 of the communication device 100 to capture an image/video of the equipment 302. The image/video of the equipment 302 may also be stored in the memory 106 of the communication device 100 for further processing. Finally, in one embodiment, the communication device 100 may be equipped with suitable location determining devices (not shown) to obtain the location of the communication device 100 and, consequently, the location of the equipment 302. For example, the communication device 100 may include a global positioning system (GPS) tracking unit used to obtain location information about the device 100. This location information may also be stored in the memory 106 of the device and included as part of the context information 310.

Furthermore, in addition to each of the above-identified ways in which context information 310 may be obtained, a technician/engineer may manually enter context information 310 into the communication device 100 using, for example, the user/input output interface 110. For example, a technician/engineer could scan an optical code 304 of the equipment 302 using the scanner 116 of the communication device 100. Thus, the obtained optical code 304 will comprise a portion of the context information 310. Additionally, the technician/engineer could use the input/output interface 110 (e.g., a keypad) of the communication device 100 to enter, for example, keywords which help describe the equipment being serviced. Further still, a technician/engineer may use the input/output interface 110 (e.g., a microphone) of the communication device to speak into a microphone using words to describe the equipment being serviced. By providing this additional information, more relevant expert information 312 may be returned to the technician/engineer.

Regardless of the manner in which the context information 310 is obtained, this context information 310 may be transmitted to the computing device 200 over the network 308. The computing device 200 uses the context information 310 to generate expert information 312. By way of example, where the context information 310 includes an optical code 304, the computing device 200 may covert the optical code 304 into keyword data representing, for example, a model number/serial number for the equipment 302 and/or a model/serial number for a component of the equipment 302. The computing device 200 may then use this keyword data as a query for searching within a database (e.g., a database stored in storage 204 of the computing device 200) containing information about the equipment 302.

Similarly, where the context information 310 includes RFID tag information 306, the computing device 200 may convert the RFID tag information into keyword data representing, for example, a model/serial number for the equipment 302 and/or a model/serial number for a component of the equipment 302. The computing device 200 may then use this keyword data as a query for searching within a database (e.g., a database stored in storage 204 of the computing device 200) containing information about the equipment 302.

Where the context information 310 includes equipment identification information 320 or component identification information 322, this information may also be converted into keyword data that may be used as a query for searching within a database (e.g., an enterprise file repository). Where the context information 310 includes an image/video of the equipment 302, the computing device may perform optical analysis on the image/video in order to ascertain additional information about the equipment 302 (e.g., a model/serial number) using techniques known in the art. In one embodiment, this additional information may be used as keyword data to form a query for searching within a database containing information about the equipment 302. In another embodiment, the image/video itself may be used as the query for searching the database using image recognition techniques known in the art.

Finally, where the context information 310 includes location information, the computing device 200 may convert this location information into keyword data to form a query for searching within a database containing information about the equipment 302. While the above-discussion focuses on using each discrete piece of context information 310 to perform a search, those having ordinary skill in the art will appreciate that all or any portion of the available context information 310 may be suitably used to perform the search. Indeed, the more context information 310 that is available for a given search, the more relevant the search results are likely to be.

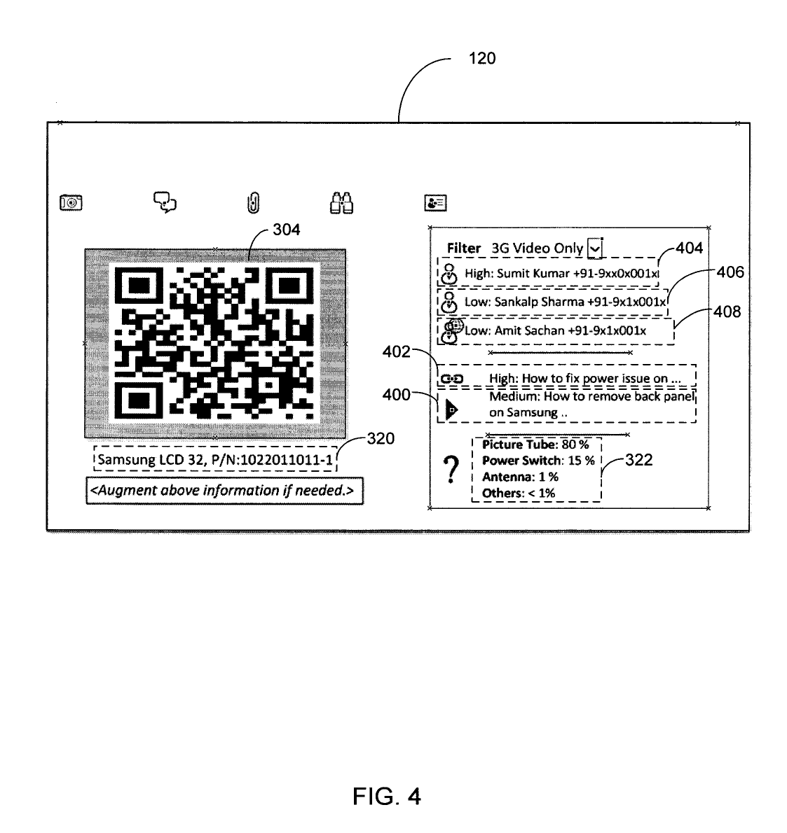

The information returned following the computing device's 200 query may form part of, or constitute the whole of, the expert information 312. As used herein, expert information 312 may include, for example, (1) solution information associated with the equipment, (2) equipment expert identification information, (3) component expert identification information, (4) local expert identification information, (5) local component expert identification information, and/or (6) equipment documentation information. Examples of these different types of expert information 310 are illustrated in the graphical user interface 120 shown in FIG. 4 and are discussed in additional detail below.

Solution information associated with the equipment describes solutions to frequently encountered problems with the equipment 302. Solution information may be obtained as follows. Where the exact type of equipment being serviced can be ascertained based on the context information 310, the computing device 200 is operative to search a database for information concerning the most frequent problems associated with that type of equipment. This process may include, for example, (1) retrieving a list of all of the components making up the equipment from the database (e.g., by consulting a table in the database storing information about all of the components in the particular type of equipment at issue), (2) retrieving all of the “frequent problem” information associated with the equipment 302 generally and all of the components from the database (e.g., the “frequent problem” information may be subsumed within documents stored in the database), (3) aggregating the retrieved data to identify a percentage of issues/problems associated with each component and/or the equipment 302 generally, and (4) filtering the aggregated data based on business rules (e.g., only returning information regarding components that are problematic in over 30% of previously analyzed service calls). As those having ordinary skill in the art will recognize, the step of filtering is optional, but may lead to more relevant search results.

The results of this process (i.e., the solution information associated with the equipment) may be compiled as part of, or the entirety of, the expert information 312 that the computing device 200 is operative to return to the communication device 100. The solution information, and the other types of expert information 312 that the computing device 200 is operative to generate, may be provided as part of the expert information 312 to the communication device 100 in any suitable form. For example, the solution information (or the other types of expert information described below) may implemented as a video (e.g., a video showing how to fix a frequently occurring problem associated with the equipment being serviced or a component thereof), a document (e.g., an electronic document), a SMS text message (e.g., including text explaining how to resolve a frequently occurring problem), an e-mail message, an image (e.g., a .JPEG image file showing a flowchart for resolving the frequently occurring problem), or any other suitable implementation known in the art.

In an example where there is no information available explaining how to solve a particular problem facing the equipment 302 being serviced (e.g., there are no files in the database concerning how to fix a frequently occurring problem associated with the equipment 302 or any components thereof), the solution information may include a list of generic documents (e.g., URL links to the generic documents describing the equipment generally, such as a user manual) or the generic documents themselves. Accordingly, this solution information (including a list of generic documents or the documents themselves) may be included as part of, or the entirety of, the expert information 312 that the computing device 200 is operative to transmit to the communication device 100.

Expert identification information includes information that describes at least one expert (e.g., a person) that is knowledgeable about the equipment generally and/or components thereof. Expert identification information may be obtained as follows. Where the exact type of equipment being serviced can be ascertained based on the context information 310, the computing device 200 is operative to search a database for information listing all experts having knowledge of that equipment. For example, the database may store a list of experts that are knowledgeable about each particular type of equipment. If there is a list of experts associated with the particular type of equipment being serviced, the results of the search will return such a list. Any experts included on such a list may be characterized as having “HIGH” relevance with regard to the equipment 302 at issue. The contact information (e.g., name, address, telephone number, email address, instant messenger name, etc.) for any experts identified may constitute the expert identification information that may be included as part of, or the entirety of, the expert information 312 that the computing device 200 is operative to transmit to the communication device 100.

Component expert identification information includes information that describes at least one expert that is knowledgeable about at least one component of the equipment 302. For example, where the exact type of equipment being serviced is unknown, or there are no experts associated with the particular type of equipment being serviced, the computing device 200 is operative to search a database for information listing all experts associated with any known component of the equipment 302. For example, where a model/serial number associated with the equipment 302 generally is not available, the computing device 200 is operative to search the database for one or more lists of experts associated with one or more known components of the equipment 302. For example, the computing device 200 is operative to use a model/serial number associated with a component of the equipment 302 to identify a list of experts associated with that component. Any experts included on this type of list may be characterized as having “LOW” relevance with regard to the equipment 302 at issue to the extent that, despite being experts regarding a particular component, they are nevertheless not experts with regard to the overall piece of equipment. The contact information (e.g., name, address, telephone number, email address, instant messenger name, etc.) for any experts identified may constitute the component expert identification information that may be included as part of, or the entirety of, the expert information 312 that the computing device 200 is operative to transmit to the communication device 100.

Local expert identification information includes information that describes at least one expert that is knowledgeable about the equipment 302 generally and located within a predefined vicinity of the equipment 302. The determination of whether a given expert is knowledgeable about the equipment generally may be made in line with the discussion on expert identification information described above. For example, the computing device 200 is operative to use any location information included as part of the context information 310 to search a database for information listing all experts known to be in the predefined vicinity of the equipment 302. As used herein, a predefined vicinity may include any suitable distance, as a matter of design choice, from the equipment 302 (e.g., within twenty miles of the location of the equipment 302). The determination of whether an expert is within the predefined vicinity of the equipment 302 may be based on any suitable location information associated with an expert, such as, but not limited to, GPS positioning data available for an expert, address information stored within the database regarding an expert, a known work schedule indicating where a given expert is expected to be at a particular time, etc. The location of a given expert in relation to the location of the equipment 302 may further affect whether that expert is characterized as being of HIGH or LOW relevance (e.g., the closer the exert is to the equipment 302, the more likely they are to be a HIGH relevance expert). The contact information (e.g., name, address, telephone number, email address, instant messenger name, etc.) for any experts identified may constitute the local expert identification information that may be included as part of, or the entirety of, the expert information 312 that the computing device 200 is operative to transmit to the communication device 100.

Local component expert identification information includes information that describes at least one expert knowledgeable about at least one component of the equipment 302 being serviced that is located within a predefined vicinity of the equipment 302. The determination of whether a given expert is knowledgeable about at least one component of the equipment may be made in line with the discussion on component expert identification information described above. The determination of whether a component expert is within the predefined vicinity of the equipment 302 may be made in line with the discussion on determining whether an expert is in the vicinity of the equipment as discussed above. Furthermore, the location of a given component expert in relation to the location of the equipment 302 may further affect whether that expert is characterized as being of HIGH or LOW relevance.

While the foregoing discussions on local expert identification information and local component expert identification information have centered on identifying “experts” located within a predefined vicinity of the equipment 302, for the purposes of the instant disclosure, an “expert” may also include a field technician who is servicing a similar type of equipment within the predefined vicinity.

Equipment documentation information includes information describing one or more documents associated with the equipment 302 or a component thereof. For example, the computing device 200 is operative to query a database using any context information 310 available (e.g., information regarding the equipment 302 generally or information regarding any components of the equipment 302) to identify any additional documents that may assist the technician/engineer in servicing the equipment 302. For example, equipment documentation information may include a list of any documents relating to the equipment 302 or any components thereof (e.g., URL links to documents describing the equipment 302 or components thereof) or the documents themselves (e.g., electronic documents describing the equipment 302 or components thereof). The equipment documentation information may be included as part, or the entirety of, the expert information 312 that the computing device 200 is operative to transmit to the communication device 100.

Once generated, the expert information 312 may be transmitted by the computing device 200 to the communication device 100 over the network 308. The technician/engineer operating the communication device 100 may then use the expert information to service the equipment 302 more efficiently and successfully. Once the technician/engineer has serviced the equipment 302, they may use the input/output interface 110 of the communication device to enter service information 314 (e.g., by typing this information into the communication device 100 using a keypad, speaking this information into a microphone of the communication device 100, or recording a video of themselves describing this information using a camera of the communication device 100). Service information 314 includes any information regarding the service applied to the equipment, including but not limited to information that describes how the equipment 302 was serviced (i.e., what procedures or fixes were applied to the equipment), who serviced the equipment, where and when the service was completed, what replacement parts were used during the service, etc. For example, the service information 314 may include a description of the component that was problematic in the equipment 302, how that component was repaired, whether that component was replaced, the name of the technician/engineer performing the service, etc. The service information 314 may be stored, for example, in the memory 106 of the communication device 100. Once the technician/engineer enters the service information 314 into the communication device 100, the communication device 100 is operative to provide that service information 314 to the computing device 200 over the network 308.

Once the service information 314 is received, the computing device 200 is operative to generate updated expert information 316 based on the service information 314. As used herein, generating updated expert information 316 includes modifying any previously existing expert information 312 associated with the equipment 302 being serviced or any components thereof. For example, this could include modifying the solution information, equipment expert identification information, component expert identification information, local expert identification information, local component expert identification information, equipment documentation information, or any combinations thereof. By modifying the expert information 312 (e.g., by updating/supplementing/replacing previous documents with new updated documents that better describe how to service equipment) based on the service information 314, the system is able to continuously increase the relevance of any expert information that is provided to technicians/engineers working in the field.

In one example, the service information 314 may be used to upgrade/downgrade the characterization of a particular technician/engineer as an expert with regard to a particular type of equipment. For example, where a technician/engineer performs a certain number of successful repairs on particular type of equipment, they may be characterized as an “expert” with regard to that type of equipment (or component, as the case may be) and may be subsequently listed in any expert information sent to another technician/engineer servicing the same type of equipment. In one embodiment, the updated expert information 316 may be transmitted to additional communication devices 318a-318n for use by other technicians/engineers in servicing equipment in line with the discussion above. Similarly, the service information 314 may be used to adjust a relevancy rating of particular documents/video/etc. (i.e., solution information and/or equipment documentation information) that may be provided as part of the updated expert information 316. For example, if service information 314 indicates that a particular document/video/etc. was especially helpful in servicing equipment, that document/video/etc. may receive a heightened relevancy rating.

FIG. 4 illustrates one example of a graphical user interface (GUI) 120 that may be generated for display on, for example, the display 118 of the communication device 100 using techniques known in the art. The GUI includes display data representative of a variety of information, including expert information as will be discussed below. In the illustrated example, the GUI 120 includes a copy of the optical code 304 obtained from the equipment 302 being serviced. Although a QR code is shown, it is recognized that the GUI could include display data representing other types of optical codes (e.g., bar codes) equally well. Alternatively, where RFID tags or the like are employed, the GUI could include the decoded information obtained from the RFID tag. The GUI also includes display data representing equipment identification information 320. Thus, in the illustrated example, the technician/engineer operating the communication device 100 displaying the GUI 120 was servicing a 32-inch Samsung™ television having the part number 1022011011-1. In addition, GUI includes display data representing component identification information 322 describing certain components of the equipment 302. The percentages listed to the right of each component may represent the likelihood that that component is the source of the problem with the equipment 302. Such likelihoods of certain components being a problem for a given piece of equipment may be determined based on collective service history for that particular brand/model of equipment. For example, the fact that the component “picture tube” has a value of 80% may indicate that the picture tube is responsible for the problem 80% of the time that a 32-inch Samsung™ television (having the relevant part number) is not operating correctly. Similarly, the fact that the component “Power Switch” has a value of 15% may indicate that the power switch is responsible for the problem 15% of the time. This information is particularly useful because it allows a technician/engineer to identify what is most likely to be the problematic component with regard to a particular piece of equipment.

However, in certain instances, (1) no one component is more likely than any other component to be responsible for equipment problems (e.g., all of the components are equally likely to be the source of the problem) or (2) no one component is responsible for causing the equipment failure in any significant number of cases (e.g., there are no components that are responsible for equipment failure in over 10% of the known cases). In such circumstances, in one embodiment of the instant disclosure, no component identification information 322 (or the percentages associated with the component identification information 322) is provided in the GUI 120. As such, a technician/engineer viewing the GUI 120 will not be inclined to test all of the components listed in the GUI 120 to see whether they are the source of the equipment problem, which can be a cumbersome task of little value.

Continuing, solution information associated with the equipment 400 may be provided along the right side of the GUI 120 as shown in FIG. 4. In the illustrated example, the solution information 400 includes a link to a video showing how to remove a back panel on a Samsung television. This video may be viewed on the display 118 of the communication device 100. The GUI 120 also includes display data representative of equipment documentation information 402. In this example, the equipment documentation information 402 includes a link to information (e.g., a document, a web page, etc.) describing how to fix a power issue on a Samsung television.

The GUI 120 also includes equipment expert identification information 404. The expert identification information 404 indicates that Sumit Kumar is a HIGH relevance expert with regard to the television at issue and provides a phone number where that expert may be reached. In this manner, a technician/engineer viewing the GUI 120 can use the communication device (in an example where the communication device 100 includes mobile phone functionality) to contact this expert for assistance in servicing the television. Furthermore, the exemplary GUI 120 also includes display data representative of component expert identification information 406. The component expert identification information 406 indicates that Sankalp Sharma is a LOW relevance expert with regard to the equipment generally, but may be an expert with respect to a particular component of the television. Finally, GUI 120 includes display data representative of local expert identification information 408. The local expert identification information 408 indicates that Amit Sachan is a LOW relevance expert with regard equipment generally. More importantly, the local expert identification information 408 indicates that Amit Sachan is located within a predefined vicinity of the television as indicated, for example, by an icon illustrating a globe behind an icon representative of a technician. While local component expert identification information is not shown in the exemplary GUI 120, those having ordinary skill in the art will appreciate that this information could also be presented as display data within the GUI 120 as desired. Regardless of what specific expert identification information 404-408 is shown, such information, as supplied by the computing device 200 for example, may include information that was previously updated as described above.

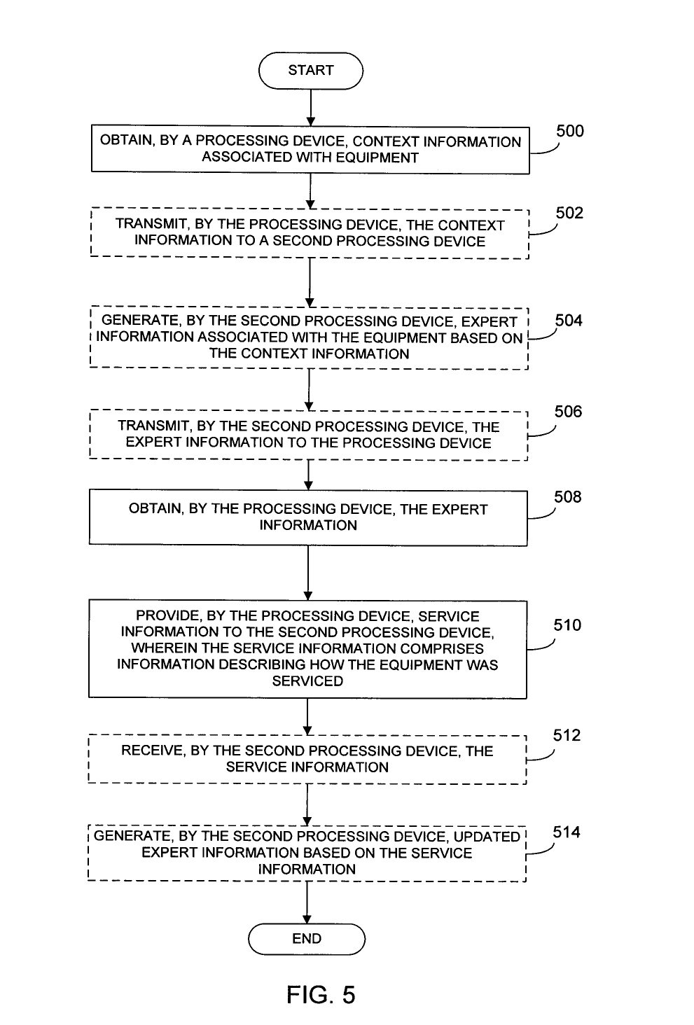

Referring now to FIG. 5, a flowchart illustrating a method for servicing equipment in accordance with the instant disclosure is provided. While the system 300 is one form for implementing the processing described herein (including that illustrated in FIG. 5), those having ordinary skill in the art will appreciate that other, functionally equivalent techniques may be employed. Furthermore, as known in the art, some or all of the functionalities implemented via executable instructions may also be implemented using firmware and/or hardware devices such as application specific integrated circuits (ASICs), programmable logic arrays, state machines, etc. Once again, those of ordinary skill in the art will appreciate the wide number of variations that may be used is this manner.

Beginning at block 500, context information associated with equipment is obtained by a first processing device (e.g., communication device 100). At block 502, the processing device transmits the context information to a second processing device (e.g., computing device 200). At block 504, the second processing device generates expert information associated with the equipment based on the context information. At block 506, the second processing device transmits the expert information to the first processing device. At block 508, the first processing device obtains the expert information. At block 510, the first processing device provides service information to the second processing device. The service information may include information describing how the equipment was serviced as described above. At block 512, the second processing device receives the service information. Finally, at block 514, the second processing device generates updated expert information based on the service information.

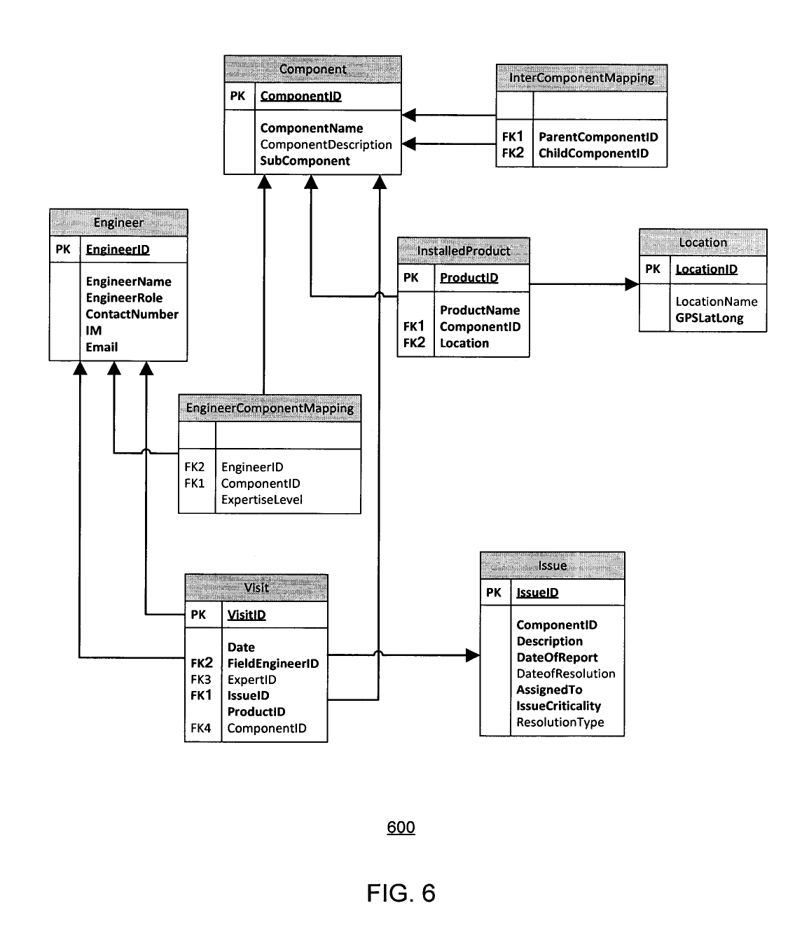

FIG. 6 is a block diagram illustrating one example of a database structure 600 for storing the information used by the system 300 for servicing equipment 302 in accordance with the instant disclosure. Such a structure would be maintained, for example, by the computing device 200 of FIG. 3. Specifically, FIG. 6 illustrates a schema for a relational database structure comprising, in the illustrated example, a number of tables linked by their respective uniquely-identifying primary keys (PK) and data-referencing foreign keys (FK), as known in the art. An Installed Product Details table has a product identification (ID) as its primary key and includes entries regarding the product name and foreign key references to specific components included in the product as well as the product location. The product location is stored in a Location table having a location ID as its primary key and including entries for a location name and specific GPS coordinates. Also linked to the Installed Product Details table, a Component table has a component ID as its primary key and includes a component name, a description of the component, and a description of any sub-components. Because individual products (or equipment) will often include multiple components having various relationships to each other, the Component table may also be linked to an Inter-Component Mapping table, as shown, which identifies specific relationships between components, e.g., components identifying as being a parent type (as in the case, for example, of a computer motherboard that can host other components) or a child type (as in the case, building on the previous example, of a computer co-processor board controlled by the motherboard).

As further shown in FIG. 6, the database structure 600 includes information regarding specific engineers/technicians, service visits performed by the engineers/technicians and their relationships to the other data included in the database structure 600. For example, an Engineer table is provided (being representative of not only engineers, but also technicians as described above) having an engineer ID as its primary key and including entries specifying an engineer/technician's name, an engineer/technician's role, an engineer/technician's contact number (e.g., telephone number), an engineer/technician's instant messaging name, and an engineer/technician's email address. To reflect expertise in specific components, an Engineer Component Mapping table is provided which includes references to specific engineers, the components with which they are familiar, and the level of expertise those engineers. Further, the illustrated example shows a Visit table having a visit ID as its primary key and including references to a date of a service visit, specific field engineers/technicians that performed the service for a given service visit, the product (or equipment) serviced during that visit, any experts identified and/or called upon during the service visit, and/or issues that came up during a visit. Finally, an Issue table is provided having an issue ID as its primary key and including references to a component ID and description, the date that a given service visit report was generated, the date that a given piece of equipment (or component thereof) was fixed (i.e., an issue was resolved), the technician/expert that was assigned to the issue, the criticality of the issue, and the type of resolution that was provided.

In keeping with the update procedure noted above, the data included in the database structure 600 may be updated in accordance with the service information 314. For example, as a given engineer/technician is associated with a threshold number of successful service visits for a given component, the Component-Engineer Mapping table could be updated to associate that engineer/technician with the component.

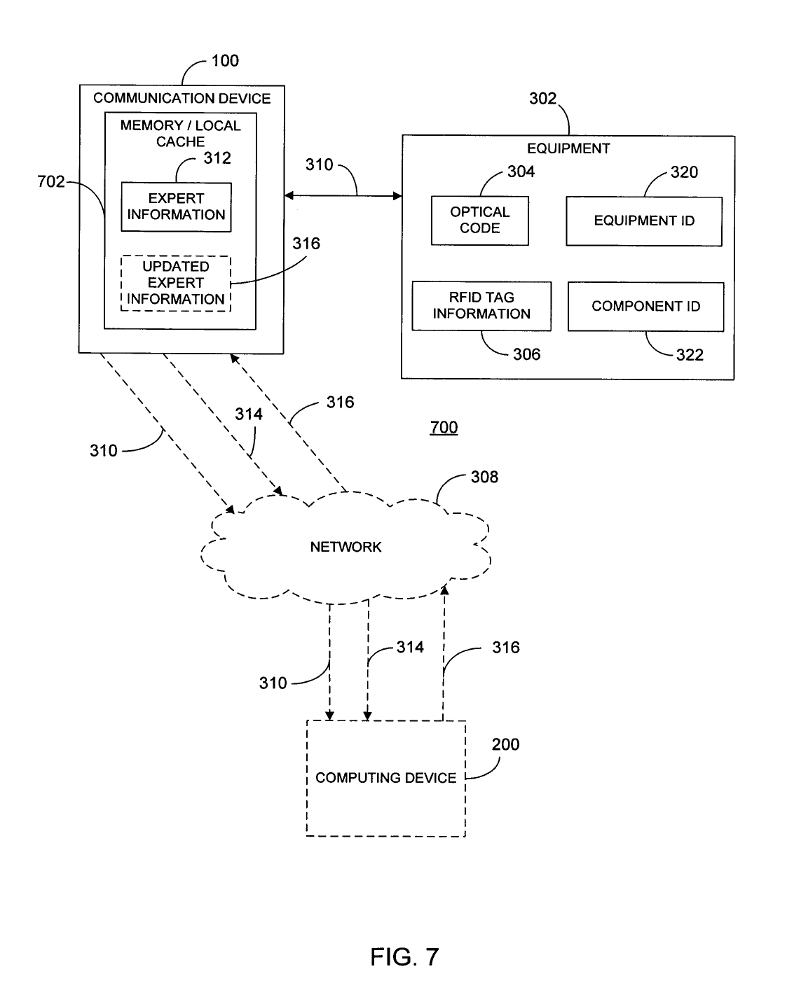

With regard to FIG. 7, another system 700 in accordance with the present disclosure is illustrated. In the illustrated example, the system 700 includes communication device 100. Communication device 100 operates substantially in accordance with the discussion of this component provided above. However, in the system 700 of FIG. 7, communication device 100 is shown having memory 702 storing expert information 312, such as the expert information discussed above. The memory 702 may be any suitable type of volatile or non-volatile memory known in the art, such as the types of memory discussed above with regard to memory 106.

Communication device 100 operates substantially in accordance with the functionality described above, however, in this example, the expert information 312 is stored locally on the communication device 100. Thus, in this embodiment, it is not necessary for the communication device 100 to obtain the expert information from a remote computing device, such as computing device 200, over a network, such as the network 308. Rather, in this embodiment, the communication device 100 may obtain the expert information 312 from its memory/local cache 702. While storage limitations may prevent memory 702 from storing all of the expert information that could be stored in a remotely located computing device 200, the instant disclosure recognizes that it may be desirable to store at least some (and perhaps all) of the same expert information locally on the communication device 100. For example, a portion or all of the solution information, equipment expert identification information, component expert identification information, local expert identification information, local component expert identification information, and/or equipment documentation information may be stored locally within the memory/local cache 702 of the communication device 100.

This embodiment may be particularly useful where the communication device 100 is unable to obtain a network connection, for example, with network 308. In such a scenario, a technician/engineer using the communication device 100 may service the equipment 302 relying on whatever expert information 312 is present on the communication device 100 itself. Additionally, for purposes of expedience and otherwise, it may be desirable for the communication device 100 to check its memory/local cache 702 for expert information 312 before seeking out expert information 312 from a remotely stored computing device, such as computing device 200. This embodiment may save valuable service time in a situation where the expert information 312 stored locally on the communication device 100 is sufficient to service the equipment 302 at issue.

In still another embodiment in line with the system 700, it may be desirable for the communication device 100 to check for network connectivity prior to obtaining expert information 312 from a remotely stored computing device 200. Techniques for checking for network connectivity are well known to those having skill in the art. Of course, where network connectivity is available, in one example, the communication device 100 may still obtain the expert information 312 (or the updated expert information 316, as the case may be) from the remotely stored computing device 200 over the network 308.

While particular embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. A method for servicing equipment, the method comprising:
obtaining, by a processing device, context information associated with the equipment;
obtaining, by the processing device, expert information associated with the equipment based on the context information;
providing, by the processing device, service information, wherein the service information comprises information describing how the equipment was serviced, and wherein the service information may be used to generate updated expert information.

2. The method of claim 1, further comprising:
transmitting, by the processing device, the context information to a second processing device;
generating, by the second processing device, the expert information associated with the equipment based on the context information;
transmitting, by the second processing device, the expert information to the processing device; and
receiving, by the second processing device, the service information; and
generating, by the second processing device, updated expert information based on the service information.

3. The method of claim 1, wherein obtaining context information associated with the equipment comprises obtaining at least one of:
equipment identification information, wherein the equipment identification information comprises information describing the equipment generally; and
component identification information, wherein the component identification information comprises information describing at least one component of the equipment.

4. The method of claim 1, wherein obtaining the context information associated with the equipment comprises at least one of:
scanning, by the processing device, an optical code associated with the equipment;
obtaining, by the processing device, RFID tag information associated with the equipment; and
obtaining, by the processing device, an image of the equipment;
obtaining, by the processing device, a video of the equipment;
obtaining, by the processing equipment, an audio description of the equipment; and
obtaining, by the processing device, a textual description of the equipment.

5. The method of claim 1, wherein obtaining the expert information associated with the equipment based on the context information comprises obtaining at least one of:
solution information associated with the equipment, wherein the solution information comprises information describing solutions to frequently encountered problems with the equipment;
equipment expert identification information, wherein the equipment expert identification information comprises information describing at least one expert knowledgeable about the equipment generally;
component expert identification information, wherein the component expert identification information comprises information describing at least one expert knowledgeable about at least one component of the equipment;
local expert identification information, wherein the local expert identification information comprises information describing at least one expert knowledgeable about the equipment generally and located within a predefined vicinity of the equipment;
local component expert identification information, wherein the local component expert identification information comprises information describing at least one expert knowledgeable about at least one component of the equipment and located within the predefined vicinity of the equipment; and
equipment documentation information, wherein the equipment documentation information comprises information describing one or more documents associated with the equipment.

6. The method of claim 2, wherein generating the updated expert information based on the service information comprises modifying at least one of:
solution information associated with the equipment, wherein the solution information comprises information describing solutions to frequently encountered problems with the equipment;
equipment expert identification information, wherein the equipment expert identification information comprises information describing at least one expert knowledgeable about the equipment generally;
component expert identification information, wherein the component expert identification information comprises information describing at least one expert knowledgeable about at least one component of the equipment;
local expert identification information, wherein the local expert identification information comprises information describing at least one expert knowledgeable about the equipment generally and located within a predefined vicinity of the equipment;
local component expert identification information, wherein the local component expert identification information comprises information describing at least one expert knowledgeable about at least one component of the equipment and located within the predefined vicinity of the equipment; and
equipment documentation information, wherein the equipment documentation information comprises information describing one or more documents associated with the equipment.

7. The method of claim 1, wherein obtaining the expert information associated with the equipment based on the context information comprises obtaining, by the processing device, the expert information from a second processing device.

8. The method of claim 7, further comprising:
checking, by the processing device, a local cache of the processing device for the expert information prior to obtaining the expert information from the second processing device.

9. The method of claim 8, further comprising:
checking, by the processing device, for network connectivity prior to obtaining the expert information from the second processing device.

10. A system for servicing equipment, the system comprising:
a first processing device; and
a second processing device in communication with the first processing device, the first processing device operative to:
obtain context information associated with the equipment;
obtain expert information associated with the equipment based on the context information; and
provide service information, wherein the service information comprises information describing how the equipment was serviced, and wherein the service information may be used to generate updated expert information.

11. The system of claim 10, wherein the first processing device is further operative to transmit the context information to the second processing device, and wherein the second processing device is operative to:
generate the expert information associated with the equipment based on the context information;
transmit the expert information to the first processing device;
receive the service information; and
generate updated expert information based on the service information.

12. The system of claim 10, wherein the first processing device is operative to obtain context information associated with the equipment by obtaining at least one of:
equipment identification information, wherein the equipment identification information comprises information describing the equipment generally; and
component identification information, wherein the component identification information comprises information describing at least one component of the equipment.

13. The system of claim 10, wherein the first processing device is operative to perform at least one of the following in order to obtain the context information associated with the equipment:
scan an optical code associated with the equipment;
obtain RFID tag information associated with the equipment; and
obtain an image of the equipment;
obtain a video of the equipment;
obtain an audio description of the equipment; and
obtain a textual description of the equipment.

14. The system of claim 10, wherein the first processing device is operative to obtain expert information associated with the equipment based on the context information by obtaining at least one of:
solution information associated with the equipment, wherein the solution information comprises information describing solutions to frequently encountered problems with the equipment;
equipment expert identification information, wherein the equipment expert identification information comprises information describing at least one expert knowledgeable about the equipment generally;
component expert identification information, wherein the component expert identification information comprises information describing at least one expert knowledgeable about at least one component of the equipment;
local expert identification information, wherein the local expert identification information comprises information describing at least one expert knowledgeable about the equipment generally and located within a predefined vicinity of the equipment;
local component expert identification information, wherein the local component expert identification information comprises information describing at least one expert knowledgeable about at least one component of the equipment and located within the predefined vicinity of the equipment; and
equipment documentation information, wherein the equipment documentation information comprises information describing one or more documents associated with the equipment.

15. The system of claim 11, wherein the second processing device is operative to generate updated expert information based on the service information by modifying at least one of the following:
solution information associated with the equipment, wherein the solution information comprises information describing solutions to frequently encountered problems with the equipment;
equipment expert identification information, wherein the equipment expert identification information comprises information describing at least one expert knowledgeable about the equipment generally;
component expert identification information, wherein the component expert identification information comprises information describing at least one expert knowledgeable about at least one component of the equipment;
local expert identification information, wherein the local expert identification information comprises information describing at least one expert knowledgeable about the equipment generally and located within a predefined vicinity of the equipment;
local component expert identification information, wherein the local component expert identification information comprises information describing at least one expert knowledgeable about at least one component of the equipment and located within the predefined vicinity of the equipment; and
equipment documentation information, wherein the equipment documentation information comprises information describing one or more documents associated with the equipment.

16. An apparatus for servicing equipment, the apparatus comprising:
a processing device; and
memory operatively connected to the processing device, the memory comprising executable instructions that when executed by the processing device cause the processing device to:
obtain context information associated with the equipment;
obtain expert information associated with the equipment based on the context information; and
provide service information, wherein the service information comprises information describing how the equipment was serviced, and wherein the service information may be used to generate updated expert information.

17. The apparatus of claim 16, the apparatus further comprising:
a transceiver operatively connected to the processing device, wherein the transceiver is operative to:
transmit the context information to a second processing device; and
obtain the expert information from the second processing device.

18. The apparatus of claim 17, wherein the executable instructions, when executed by the processing device, further cause the processing device to obtain the expert information by causing the processing device to check for network connectivity prior to obtaining the expert information from the second processing device.

19. The apparatus of claim 16, wherein the memory further comprises the expert information, and wherein the executable instructions, when executed by the processing device, further cause the processing device to obtain the expert information by causing the processing device to obtain the expert information from the memory.

20. A computer-readable medium comprising executable instructions that when executed by a first processing device cause the first processing device to:
obtain context information associated with equipment;
obtain expert information associated with the equipment based on the context information; and
provide service information to a second processing device, wherein the service information comprises information describing how the equipment was serviced, and wherein the service information may be used to generate updated expert information.

21. The computer-readable medium of claim 20, wherein the executable instructions, when executed by the first processing device, further cause the first processing device to:
transmit the context information to the second processing device; and
obtain the expert information from the second processing device.

22. The computer-readable medium of claim 20, wherein the executable instructions, when executed by the first processing device, further cause the first processing device to:
check for network connectivity prior to obtaining the expert information from the second processing device.

23. The computer readable medium of claim 20, wherein the executable instructions, when executed by the first processing device, further cause the first processing device to obtain context information associated with the equipment by causing the first processing device to obtain at least one of:
equipment identification information, wherein the equipment identification information comprises information describing the equipment generally; and
component identification information, wherein the component identification information comprises information describing at least one component of the equipment.

24. The computer readable medium of claim 20, wherein the executable instructions, when executed by the first processing device, further cause the first processing device to obtain context information associated with the equipment by causing the first processing device to:
scan an optical code associated with the equipment;
obtain RFID tag information associated with the equipment; and
obtain an image of the equipment;
obtain a video of the equipment;
obtain an audio description of the equipment; and
obtain a textual description of the equipment.

25. The computer readable medium of claim 20, wherein the executable instructions, when executed by the first processing device, further cause the first processing device to obtain expert information associated with the equipment based on the context information by causing the first processing device to obtain at least one of:
solution information associated with the equipment, wherein the solution information comprises information describing solutions to frequently encountered problems with the equipment;
equipment expert identification information, wherein the equipment expert identification information comprises information describing at least one expert knowledgeable about the equipment generally;
component expert identification information, wherein the component expert identification information comprises information describing at least one expert knowledgeable about at least one component of the equipment;
local expert identification information, wherein the local expert identification information comprises information describing at least one expert knowledgeable about the equipment generally and located within a predefined vicinity of the equipment;
local component expert identification information, wherein the local component expert identification information comprises information describing at least one expert knowledgeable about at least one component of the equipment and located within the predefined vicinity of the equipment; and
equipment documentation information, wherein the equipment documentation information comprises information describing one or more documents associated with the equipment.

26. A computer-readable medium comprising executable instructions that when executed by a second processing device cause the second processing device to:
generate expert information associated with equipment based on context information;
transmit the expert information to a first processing device;
receive service information from the first processing device, wherein the service information comprises information describing how the equipment was serviced, and wherein the service information may be used to generate updated expert information; and
generate updated expert information based on the service information.

27. The computer readable medium of claim 26, wherein the executable instructions, when executed by the second processing device, further cause the second processing device to generate the updated expert information based on the service information by causing the second processing device to modify at least one of:
solution information associated with the equipment, wherein the solution information comprises information describing solutions to frequently encountered problems with the equipment;
equipment expert identification information, wherein the equipment expert identification information comprises information describing at least one expert knowledgeable about the equipment generally;
component expert identification information, wherein the component expert identification information comprises information describing at least one expert knowledgeable about at least one component of the equipment;
local expert identification information, wherein the local expert identification information comprises information describing at least one expert knowledgeable about the equipment generally and located within a predefined vicinity of the equipment;
local component expert identification information, wherein the local component expert identification information comprises information describing at least one expert knowledgeable about at least one component of the equipment and located within the predefined vicinity of the equipment; and
equipment documentation information, wherein the equipment documentation information comprises information describing one or more documents associated with the equipment.
